(19) United States
(12) Patent Application Publication
(10) Pub. No.: US 2010/0108704 A1
(43) Pub. Date: May 6, 2010

(54) GLASS HOLDER

(76) Inventor: Lisa A Spera, Williamstown, NJ (US)

Correspondence Address: PAUL AND PAUL, 2000 MARKET STREET, SUITE 2900, PHILADELPHIA, PA, 19103, US

(21) Appl. No.: 12/575,030

(22) Filed: Oct. 7, 2009

Related U.S. Application Data
(60) Provisional application No. 61/110,004, filed on Oct. 31, 2008.

(51) Int. Cl. B65D 25/20; B32B 3/10

(52) U.S. Cl. 220/743; 428/131; 428/136

(57) ABSTRACT

A blank capable of being formed into a drinking glass holder and a drinking glass holder itself are provided, in which a sheet of generally flexible material is provided with access holes for receiving a string or cord threaded therethrough, with ends of string or cord being adapted to be engaged with each other and with the string or cord being carried around the neck of a user, for hands-free carrying of a drinking glass via the holder.

### CROSS-REFERENCE TO RELATED TO RELATED APPLICATIONS

This is application is based upon U.S. Provisional Patent Application 61/110,004, filed Oct. 31, 2008, the complete disclosure of which is herein incorporated by reference, and upon which priority is claimed.

### BACKGROUND OF THE INVENTION

This invention is addressed to the ability to hold and carry a glass such as a wine glass.

### SUMMARY OF INVENTION

This invention is addressed to the ability to hold and carry a glass, such as a wine glass, via a cord around one's neck, in order to leave one's hands free to accomplish other tasks.

In many situations, most particularly social situations, such as cocktail parties, picnics and the like, it is desirable to have the ability to keep one's hands free for greeting people, shaking hands, eating snacks, hors d'oeuvres or the like.

Most particularly, it has become commonplace that wine is served as a cocktail.

Particularly in situations where there are large numbers of people, if one sets down a drinking glass, such as a wine glass, it may be cleaned up or picked up or drunk from by someone else. While it is known that identifying colored rings exist to place around the base of a wine glass to identify it as one's own, that does not adequately address the situation where is desired to keep one's wine glass readily at hand, while yet leaving one's hands free for other activities.

The same situation can exist in instances other than social situations, such as when one is dealing with children, doing household chores, cooking or the like, while enjoying a glass of wine.

The present invention is therefore addressed to providing a glass holder, most particularly for a wine glass, that enables one to carry the wine glass by a cord, that hangs from one's neck.

### BRIEF DESCRIPTION OF THE DRAWING FIGURES

FIG. 1 is an illustration of a blank, with a cord, for wrapping around a drinking glass, such as a wine glass.

FIG. 2 is a front elevation view of the blank of FIG. 1, disposed about a wine glass.

### DETAILED DESCRIPTION OF THE PREFERRED EMBODIMENTS

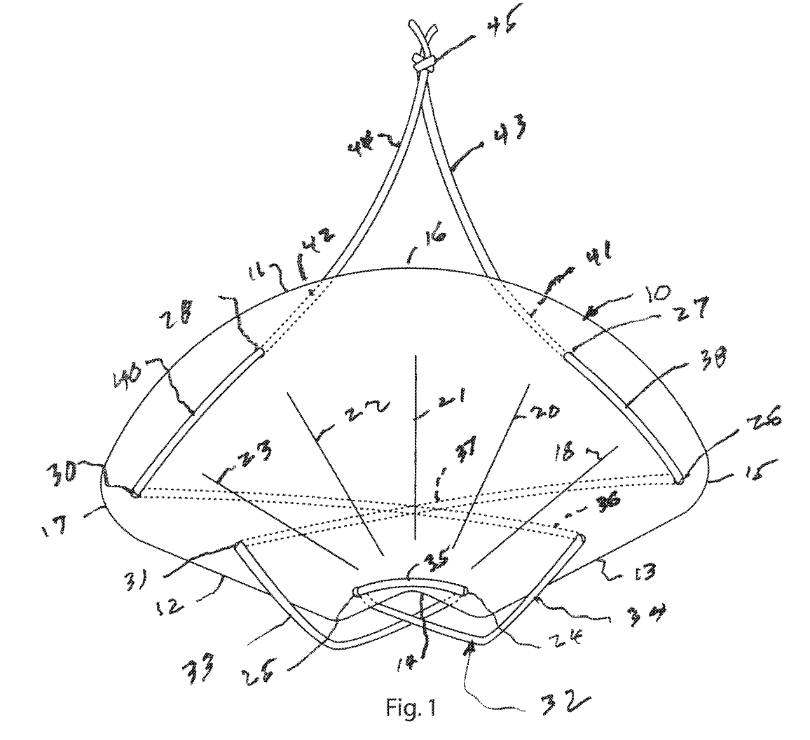

With reference to FIG. 1, it will be seen that there is a flexible blank generally designated by the numeral 10, having a generally arcuate upper edge 11, with a pair of substantially flat edges 12 and 13 at the lower end thereof, with an upwardly extending inverted V shaped notch 14, and with the various edges 15, 16 and 17 being arcuatel configured.

A plurality of slits 18, 20, 21, 22 and 23 exist in the otherwise generally flat blank 10, to enable it to conform to the rounded surface of a wine glass, about which the blank is to be wrapped during use.

A plurality of access openings 24, 25, 26, 27, 28, 30 and 31 are provided, in the form of holes, located as shown in FIG. 1, for receipt of a cord 32 therein, threaded as shown in FIG. 1, with cord portions 33, 34 and 35 on the front surface of the blank or sheet of material 10, and with other cord portions 36, 37, extending across the back of the blank or sheet 10, and shown in phantom, then passing through holes or openings 26, 30 to the front, at 38, 40, then passing through holes or openings 27, 28, to again appear in phantom at 41, 42, thereafter extending upwardly as shown at 43, 44, coming together in a knot at 45, as shown in FIG. 1.

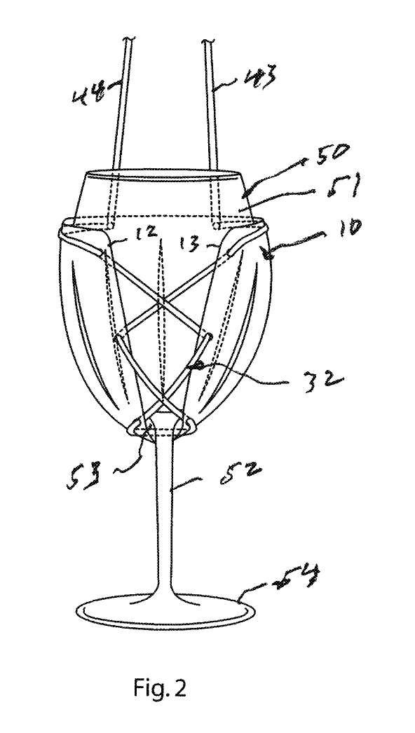

With reference to FIG. 2, it will now be seen that the sheet or blank 10 is wrapped around a wine glass 50, as shown, with the cord 32 pulled tight, bringing the edges 12, 13 of the blank toward each other, with a space therebetween, as shown in FIG. 2, with the cord portions 43, 44 extending upwardly, in a loop, as shown in FIG. 1, which loop of cord 32 can be placed over the neck of a person using the wine glass holder.

The wine glass 50 is constructed in a conventional manner, to have an upper bulbous portion 51, a stem 52 extending through a lower opening of the wine glass holder as shown, and with a base 54 connected to the stem 52, in a conventional manner

It will thus be seen that with the wine glass holder formed as a blank, and wrapped around the upper portion 51 of the wine glass 50, the same can readily be carried around the neck of a user, leaving the user's hands free.

The holder, made from a blank, can he made of many materials, such as vinyl, suede, leather. etc, and its cord can be of any desired length, and may be adjustable depending upon the size of a person using it, with such adjustment being made by where one ties the knot 45 at the upper ends 43, 44 of the cord.

The blank can be cut on a press, with the slits 18, 20, 21, 22, and 23 being simultaneously cut therewith, as well as the holes being simultaneously cut therewith, and the cord 32 can thereafter be threaded through the holes as shown in FIG. 1.

The slits and laced holes allow the blank 10 to contour to different size wine glasses. The weight of the glass and wine hanging around the neck will keep the holder snug around the wine glass.

1. A blank capable of being formed into a drinking glass holder comprising:
a flexible sheet of material bounded by a perimeter having an upper edge with a pair of side edges, the side edges forming a generally obtuse angle there between, and a bottom edge; with a plurality of access holes about the perimeter of the blank for accommodating a string or cord for wrapping the blank about the exterior of a drinking glass.

2. The blank of claim 1, further comprising a plurality of slits extending from above the bottom edge and below the upper edge of the flexible sheet of material.

3. A drinking glass holder comprising the blank and string or cord of claim 1 with the string or cord threaded through the plurality of access holes and having opposite ends of the string or cord being free of said access holes such that upon tightening said string or cord, said pair of side edges are pulled together into general conformity to the exterior of the drinking glass.

4. The drinking glass holder of claim 3, wherein said string or cord is of sufficient length to have its free ends connected, to be worn around a user's neck.

5. The drinking glass holder of claim 4, wherein said string or cord has a variable length capable of being adjusted and set by a user.

6. The drinking glass holder of claim 3, wherein the sheet of material is of generally scallop-shell shape and is made of any one of vinyl, suede, cloth and leather.

7. The drinking glass holder of claim 3, wherein the string or cord is made of any one of vinyl, suede, cloth, leather, or a textile material.

8. A combination drinking glass holder and glass comprising the glass holder of claim 3, such that said sheet of material is in a generally conical shape and has an opening at a lower tip, with the glass having a stem, wherein the glass rests within the generally conical shape of said drinking glass holder and protrudes through said opening at said lower tip of said generally conical shape.

9. The combination of claim 8, wherein said string or cord comprises a loop and is of sufficient length to be worn around a user's neck and allow the user to drink from said glass.

10. The combination of claim 9, wherein said loop of cord has a variable length capable of being adjusted and set by a user.
